(19) United States
(12) Patent Application Publication
(10) Pub. No.: US 2023/0101592 A1
(43) Pub. Date: Mar. 30, 2023

(54) COMMODITY REGISTRATION APPARATUS, SETTLEMENT SYSTEM, SETTLEMENT METHOD, AND NON-TRANSITORY COMPUTER READABLE MEDIUM STORING SETTLEMENT PROGRAM

(71) Applicant: NEC Platforms, Ltd., Kawasaki-shi, Kanagawa (JP)

(72) Inventors: Takahiro Minami, Kanagawa (JP); Makoto Kuzukubo, Kanagawa (JP); Miho Inoue, Kanagawa (JP); Ryota Kagiwada, Kanagawa (JP); Tatsuyuki Yazawa, Kanagawa (JP); Yuki Kobata, Kanagawa (JP)

(73) Assignee: NEC Platforms, Ltd., Kawasaki-shi, Kanagawa (JP)

(21) Appl. No.: 17/795,093

(22) PCT Filed: Dec. 9, 2020
(86) PCT No.: PCT/JP2020/045860

§ 371 Date: Jul. 25, 2022

(30) Foreign Application Priority Data
Feb. 4, 2020 (JP) 2020-017174

(51) Int. Cl. G06Q 20/10; G06Q 20/20; G07G 1/06; G07G 1/00; G06V 20/52; G06V 40/16

(52) U.S. Cl. CPC G06Q 20/102; G06Q 20/208; G06V 20/52; G06V 40/172; G07G 1/06; G07G 1/0081

(57) ABSTRACT

An object is to provide a commodity registration apparatus capable of, even when a plurality of customers use one shopping cart together, enabling each of the customers to know the share of the total price he/she needs to individually pay. A commodity registration apparatus according to the present invention includes: a reading unit configured to read commodity identification information for identifying a commodity; an image pickup unit configured to photograph a customer who has made the reading unit read the commodity identification information; and a control unit configured to identify the customer, store the identified customer and commodity information corresponding to the commodity identification information in a storage unit while associating them with each other, receive an input made through an operation performed on an input unit by the customer, and output the customer and the commodity information to an output unit while associating them with each other.

### TECHNICAL FIELD

The present invention relates to a commodity registration apparatus, a settlement system, a settlement method, and a non-transitory computer readable medium storing a settlement program.

### BACKGROUND ART

In general, when a customer does shopping at a supermarket or a shopping center, he/she needs to put commodities he/she wants to purchase into a shopping basket or a shopping cart, and then carry them to a cash register to pay for them. Therefore, the customer can know the total price of the commodities for the first time at the register, i.e., the customer cannot know the total price while in the middle of shopping.

Patent Literature 1 discloses a technology for a self-settlement shopping cart that enables a customer to know the total price of commodities he/she has put in a basket placed on the shopping cart even while in the middle of shopping, and also to pay for the commodities himself/herself without having to carry them to a cash register.

### Citation List

### Patent Literature

Patent Literature 1: Japanese Unexamined Patent Application Publication No. 2001-344660

### SUMMARY OF INVENTION

### Technical Problem

The above-described shopping cart enables a customer to know all the commodities put in the cart and the total price thereof. However, in the case where a plurality of persons (i.e., customers) use one cart, each of the plurality of persons cannot individually know the commodities selected by that person and the price thereof.

It is common that a group of a plurality of persons such as family members or friends use one cart. In such cases, the below-described measures need to be taken.

For example, in the case where a plurality of friends visit an apparel store together, each person puts commodities he/she wants to buy into a cart, and one of them pays a lump sum for all the commodities in at a cash register. After that, they need to calculate prices they need to individually pay by checking the receipt, and thereby to settle the total price among them.

Further, in the case where, for example, a plurality of persons purchase foodstuffs for a barbecue, one of them also pays a lump sum for all the foodstuffs at a cash register. After that, an equal share of the total price for each person is calculated and then each person pays this share of the total price. However, in some cases, among the commodities for which an equal share of the total price should be paid by each person, there are commodities for which the prices should be excluded from the total price, such as cigarettes and alcohol, which only some of the persons want to purchase due to their individual preferences. In such cases, it is also necessary to calculate prices they need to individually pay by checking the receipt.

As described above, in the technology disclosed in Patent Literature 1, there is a problem that when a plurality of customers use one shopping cart together, they have to do another calculation in order to know prices they need to individually pay.

The present invention has been made in order to solve the above-described problem, and an object thereof is to provide a commodity registration apparatus, a settlement system, a settlement method, and a non-transitory computer readable medium storing a settlement program capable of, even when a plurality of customers use one shopping cart together, enabling each of the customers to know the share of the total price he/she needs to individually pay.

### Solution to Problem

A commodity registration apparatus according to the present invention includes: a reading unit configured to read commodity identification information for identifying a commodity; an image pickup unit configured to photograph a customer who has made the reading unit read the commodity identification information; a storage unit configured to store commodity information of a commodity that the customer purchases; an output unit configured to output the commodity information; an input unit configured to receive an input made through an operation performed by the customer; and a control unit configured to control the reading unit, the image pickup unit, the storage unit, the output unit, and the input unit, in which the control unit acquires the commodity information based on the commodity identification information received from the reading unit, identifies the customer based on a photograph image received from the image pickup unit, and stores, in the storage unit, the acquired commodity information and the identified customer as commodity registration information while associating them each other, and the control unit outputs the customer and the commodity information to the output unit while associating them with each other.

A settlement system according to the present invention includes the above-described commodity registration apparatus, and a POS terminal capable of communicating with the commodity registration apparatus.

A settlement method according to the present invention includes: a step of reading commodity identification information for identifying a commodity; a step of photographing a customer who has made an apparatus read the commodity identification information; a step of acquiring commodity information based on the commodity identification information, identifying the customer based on a photograph image, and storing the acquired commodity information and the identified customer while associating them with each other; and a step of outputting the commodity information and the customer while associating them with each other.

A settlement program according to the present invention causes a computer to perform: a step of reading commodity identification information for identifying a commodity; a step of photographing a customer who has made an apparatus read the commodity identification information; a step of acquiring commodity information based on the commodity identification information, identifying the customer based on a photograph image, and storing the acquired commodity information and the identified customer while associating them with each other; and a step of outputting the commodity information and the customer while associating them with each other.

### Advantageous Effects of Invention

According to the present invention, it is possible to provide a commodity registration apparatus, a settlement system, a settlement method, and a non-transitory computer readable medium storing a settlement program capable of, even when a plurality of customers use one shopping cart together, enabling each of the customers to know the share of the total price he/she needs to individually pay.

### BRIEF DESCRIPTION OF DRAWINGS

FIG. 1 is a block diagram showing a configuration of a commodity registration apparatus according to a first example embodiment;

FIG. 2 shows a configuration of a shopping cart including a commodity registration apparatus according to a second example embodiment;

FIG. 3 is a diagram for explaining a commodity registration apparatus according to the second example embodiment;

FIG. 4 is a diagram for explaining a commodity registration apparatus according to the second example embodiment;

FIG. 5 shows an example of an image displayed in the commodity registration apparatus according to the second example embodiment;

FIG. 6 shows an example of an image displayed in the commodity registration apparatus according to the second example embodiment;

FIG. 7 shows an example of an image displayed in the commodity registration apparatus according to the second example embodiment;

FIG. 8 shows an example of an image displayed in the commodity registration apparatus according to the second example embodiment;

FIG. 9 shows an example of an image displayed in the commodity registration apparatus according to the second example embodiment;

FIG. 10 is a flowchart showing processed performed by the commodity registration apparatus according to the second example embodiment;

FIG. 11 is a flowchart showing processed performed by the commodity registration apparatus according to the second example embodiment;

FIG. 12 is a flowchart showing processes performed by a POS terminal according to the second example embodiment;

FIG. 13 is a flowchart showing processes performed by the POS terminal according to the second example embodiment;

FIG. 14 is a block diagram showing a configuration of a settlement system according to the second example embodiment;

FIG. 15 is a block diagram showing a configuration of a settlement system according to a third example embodiment; and

FIG. 16 shows an example of a hardware configuration of a commodity registration apparatus according to the third example embodiment.

### EXAMPLE EMBODIMENT

### First Example Embodiment

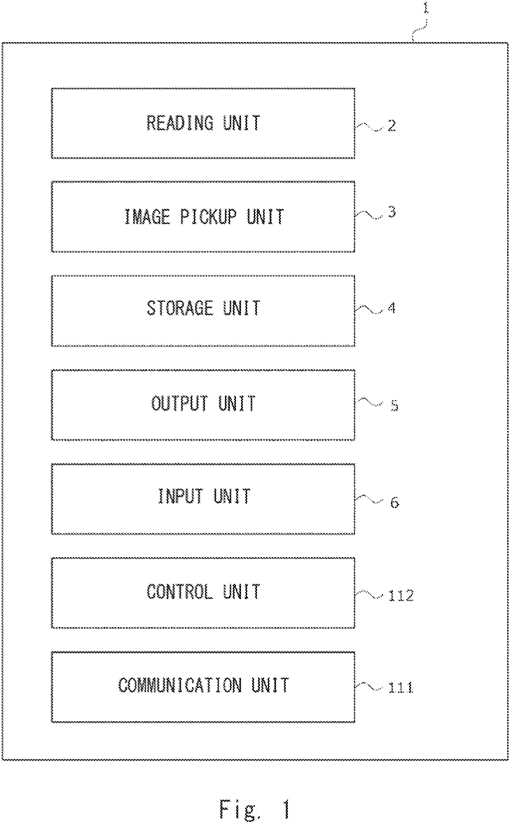

A commodity registration apparatus according to a first example embodiment of the present invention will be described with reference to FIG. 1. The commodity registration apparatus 1 is a commodity registration apparatus capable of, even when a plurality of customers use one shopping cart together, enabling each of the customers to know the share of the total price he/she needs to individually pay.

The commodity registration apparatus 1, which is provided in a shopping cart and servs as an apparatus that registers commodities a customer(s) will purchase, includes a reading unit 2, an image pickup unit 3, a storage unit 4, an output unit 5, an input unit 6, a communication unit 111, and a control unit 112. The reading unit 2 reads commodity identification information for identifying a commodity. The image pickup unit 3 photographs a customer who has made the reading unit 2 read the commodity identification information. In the storage unit 4, information about the customer, who has made the reading unit 2 read the commodity identification information, obtained based on a photograph image of the customer taken by the image pickup unit 3, and commodity information (such as a commodity name and a unit price) corresponding to the commodity identification information are stored in a state in which the information about the customer and the commodity information are associated with each other. The output unit 5 outputs a commodity(ies) and a customer while associating them with each other. The input unit 6 receives an input made by a customer. The communication unit 111 wirelessly communicates with other apparatuses (e.g., a POS (Point Of Sales) terminal). The control unit 112 is connected to each of the units, and controls them.

According to the commodity registration apparatus in accordance with this example embodiment, a customer who has made the reading unit 2 read commodity identification information of a commodity, and commodity information corresponding to this commodity identification information are stored in a state in which they are associated with each other, so that even when a plurality of customers use one shopping cart together, it is possible to enable each of the customers to know the amount he/she needs to individually pay.

### Second Example Embodiment

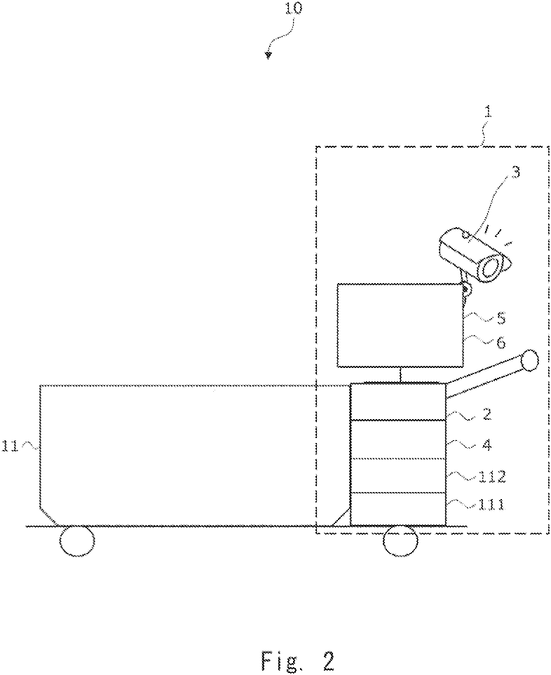

A commodity registration apparatus according to this example embodiment will be described with reference to FIG. 2. FIG. 2 is a schematic diagram showing a configuration of a shopping cart 10 including a commodity registration apparatus 1 according to this example embodiment.

As shown in FIG. 2, the shopping cart 10 includes the commodity registration apparatus 1 and a basket 11. As described in the first example embodiment, the commodity registration apparatus 1 includes a reading unit 2, an image pickup unit 3, a storage unit 4, an output unit 5, an input unit 6, a communication unit 111, and a control unit 112.

As described in the first example embodiment of the present invention, the reading unit 2 reads commodity identification information for identifying a commodity. The commodity identification information is, for example, a bar code, a QR code (Registered Trademark), a commodity number, or the like. The reading unit 2 is, for example, a bar-code reader that reads a bar code on a commodity.

The image pickup unit 3 photographs, when a customer has made the reading unit 2 read commodity identification information of a commodity, the face of the customer. The image pickup unit 3 is composed of (i.e., formed by), for example, a digital camera. Instead of or in addition to the face of the customer, any part of the customer other than the face, such as the upper body, the whole body, a watch, an accessory, or the like by which the customer can be identified may be photographed. The image pickup unit 3 may be disposed at an appropriate place where the image pickup unit 3 can photograph these parts. The image pickup unit 3 may operate in synchronization with the reading unit 2. For example, the image pickup unit 3 may photograph the customer at a timing at which the reading unit 2 reads commodity identification information.

In the storage unit 4, the image of the customer who has made the reading unit 2 read the commodity identification information, and commodity information (such as a commodity name and a unit price) corresponding to the read commodity identification information are stored by the control unit 112 in a state in which the image of the customer and the commodity information are associated with each other. The control unit 112 acquires the commodity information corresponding to the commodity identification information by referring to a PLU (Price Look Up) table stored in the storage unit 4. The control unit 112 may acquire the commodity information from other apparatuses (e.g., from a POS terminal) by transmitting the commodity identification information to the other apparatus. The control unit 112 can identify each customer shown in a respective image taken by the image pickup unit 3 by using a face authentication function or the like. As a result, the control unit 112 can associate the commodity information corresponding to the commodity identification information read by the reading unit 2 with the image information of the customer who has performed the reading operation, and store them in the storage unit 4.

In this example embodiment, the output unit 5 and the input unit 6 are composed of (i.e., formed by) a display equipped with a touch panel. The control unit 112 makes the output unit 5 output the information stored in the storage unit 4 while associating the commodity information and the customer with each other. The output information may be composed of just letters and numbers, or may include an image of the customer taken by the image pickup unit 3. The input unit 6 receives an input when the customer performs an operation such as changing the number of commodities or cancelling a commodity. The output unit 5 may be a printer capable of issuing a receipt. Further, the output unit 5 may have a sound output function (or a voice output function).

The output unit 5 may output, whenever identification information of a commodity is read by a customer, the identification information, or may output identification information of a commodity at an arbitrary timing desired by a customer. Alternatively or additionally, the output unit 5 may output identification information when a predetermined time has elapsed.

The communication unit 111 can wirelessly communicate with a POS terminal 120 or a server 130 installed in the store.

The basket 11 is a box in which the customer puts commodities he/she will purchase until the settlement of them is carried out, and is placed on the shopping cart 10. Only one basket 11 may be placed on the shopping cart 10, or two or more baskets 11 may be placed on the shopping cart 10.

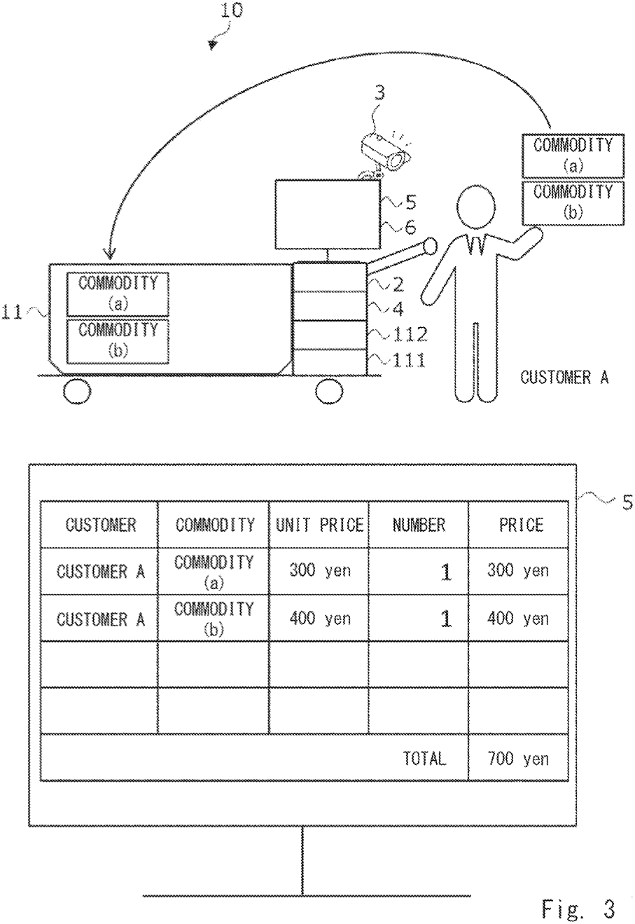

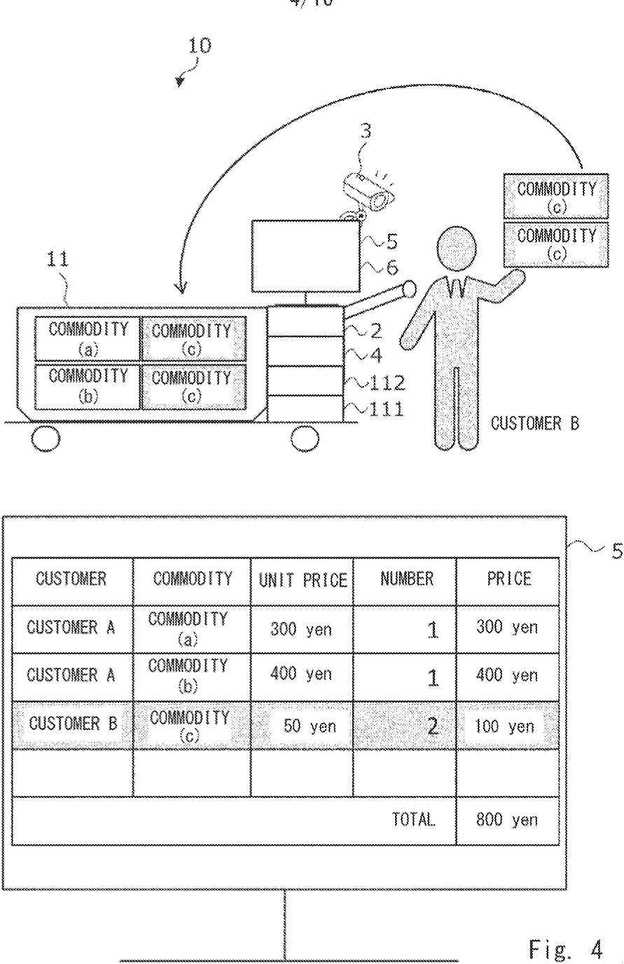

Operations that are performed by the commodity registration apparatus 1 when customers A and B do shopping while using one shopping cart 10 together will be described with reference to FIGS. 3 and 4. It is assumed that a bar code containing commodity identification information is attached on each commodity, and the commodity registration apparatus 1 including the reading unit 2, the image pickup unit 3, the storage unit 4, the output unit 5, the input unit 6, the communication unit 111, and the control unit 112, and the basket 11 are provided in the shopping cart 10. Further, it is assumed that a display equipped with a touch panel is used as the output unit 5 and the input unit 6, and the customers A and B operate the commodity registration apparatus 1 as required.

Firstly, as shown in FIG. 3, the customer A puts commodities (a) and (b) he/she wants to purchase into the basket 11. When doing so, the customer A makes the reading unit 2 read the bar codes attached to the commodities (a) and (b), respectively. At the same time, i.e., when the bar codes are read, the image pickup unit 3 takes an image of the face (hereinafter also referred to as the face image) of the customer A. The control unit 112 stores the face image of the customer A and the commodity information of the commodities (a) and (b) in the storage unit 4 while associating them with each other. With this, the registration of the commodities (a) and (b) by the customer A are completed.

In the output unit 5, commodity information, such as commodity names, unit prices, and numbers of commodities, of the commodities (a) and (b), for which the reading have been performed, and the customer A, who has registered the commodities, are displayed in a state (e.g., in a format) in which the customer A is associated with the commodity information. Further, the output unit 5 displays the total price of the commodities (a) and (b) put in the basket 11.

Next, as shown in FIG. 4, the customer B puts two commodities (c) he/she wants to purchase into the basket 11. Similarly to the customer A, the customer B makes the reading unit 2 read the bar codes attached to the commodities (c). At the same time, the image pickup unit 3 takes an image of the face of the customer B. The control unit 112 stores the face image of the customer B and the commodity information of the commodities (c) in the storage unit 4 while associating them with each other. With this, the registration of the commodities (c) by the customer B are completed.

As shown in FIG. 4, in the output unit 5, in addition to the commodity information of the commodities (a) and (b) already registered by the customer A, commodity information of the commodities (c) registered by the customer B is displayed in a state in which the customer B is associated with the commodity information. Further, the total price of the commodities (a), (b) and (c) put in the basket 11 are also displayed in the output unit 5. The images of the customers A and B may be displayed in the output unit 5 in a state in which they are associated with the respective commodity information.

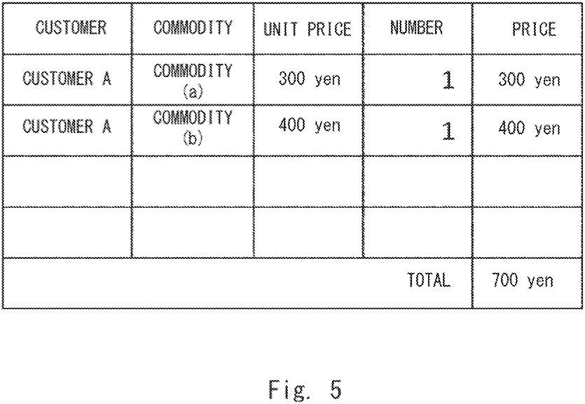

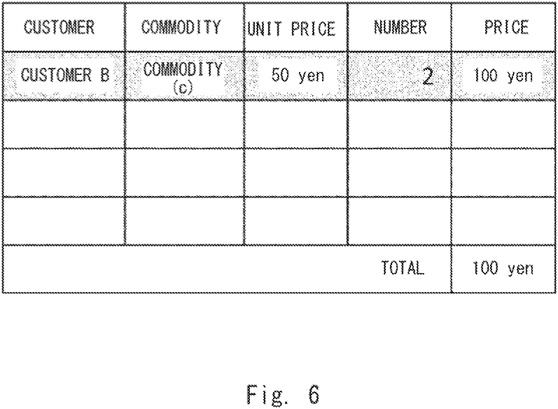

As shown in FIGS. 5 and 6, in the output unit 5, the individual settlement amounts (i.e., settlement amounts of money) for the customers A and B can be displayed at timings desired by the customers in a switched manner. Therefore, the customers A and B can easily recognize the settlement amounts they should pay even while in the middle of shopping.

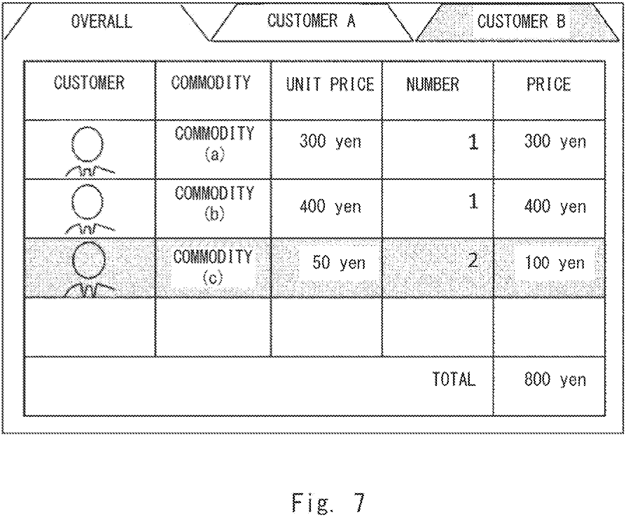

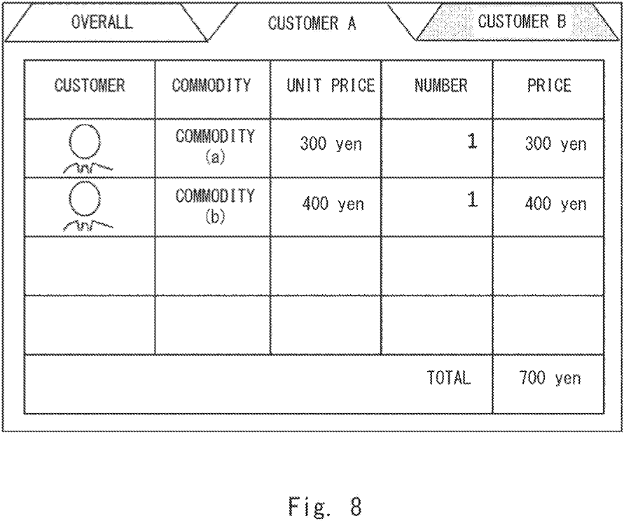

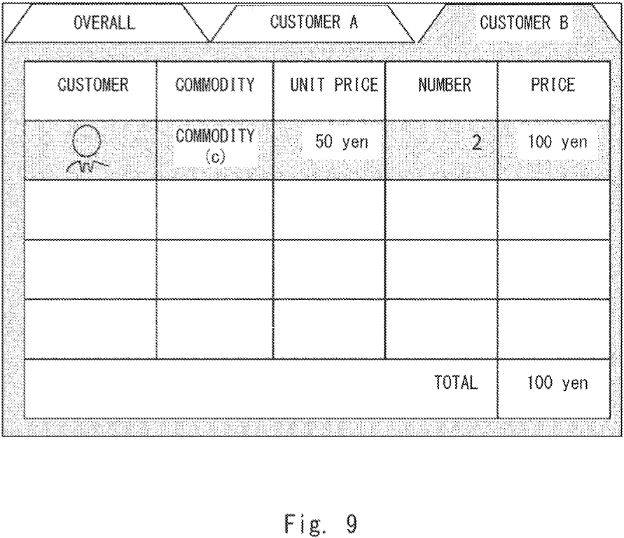

Regarding the display method used in the output unit 5, as shown in FIGS. 7 to 9, it is effective to display a list of all the settlement amounts and lists of individual settlement amounts in a switched manner by using tabs. The face images of the customers A and B may be displayed so that they may be arranged side by side with the commodities registered by the customers A and B, respectively, or the colors of displayed information or the like may be changed according to the customers, so that the customers A and B can recognize their respective commodity registration situations more easily.

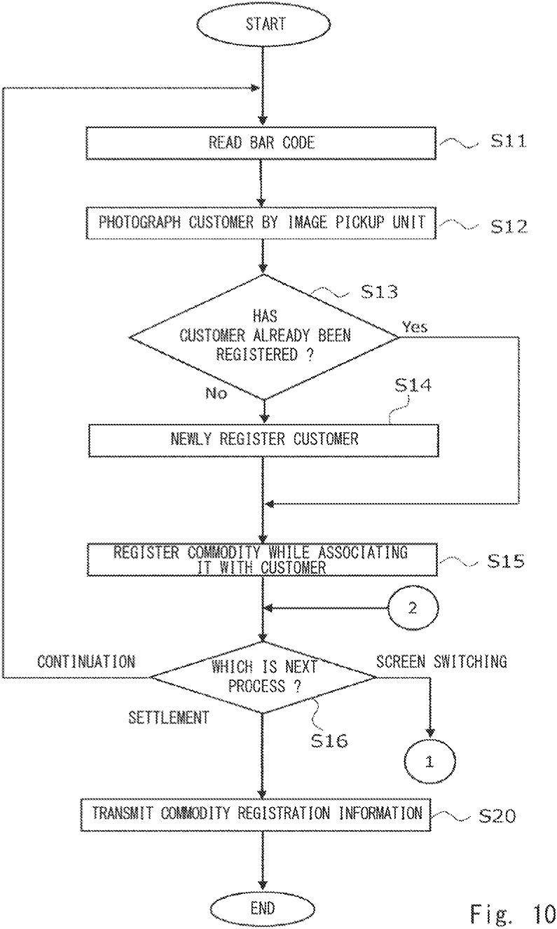

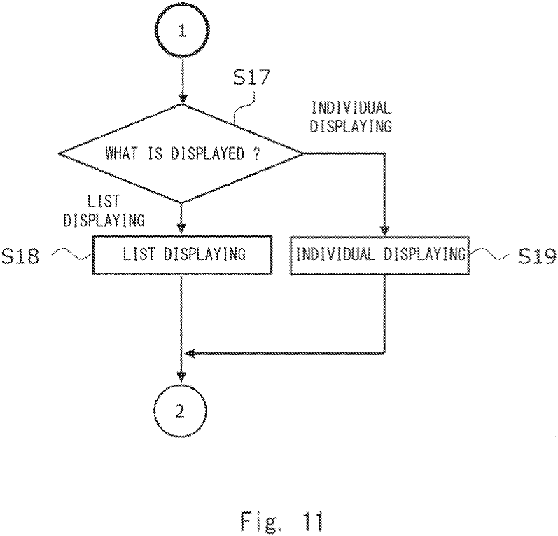

Next, processes performed by the control unit 112 of the commodity registration apparatus 1 will be described with reference to flowcharts shown in FIGS. 10 and 11.

Firstly, the customer A makes the reading unit 2 read the bar code of the commodity (a) (Step S11). The image pickup unit 3 photographs the face of the customer A (Step S12).

The control unit 112 identifies the customer A from the taken face image and determines whether or not the image of the customer A has already been registered (Step S13). When the customer A has made the reading unit 2 read a commodity for the first time (No in Step S13), the control unit 112 newly registers the customer A (Step S14). When the customer A made the reading unit 2 read a commodity at least once in the past (Yes in Step S13), the customer A has already been registered, so that the process proceeds to the next process.

The control unit 112 stores commodity information of the commodity (a), of which the bar code has been read, and the taken image of the customer A while associating them with each other (Step S15). With this, the registration of the commodity (a) by the customer A is completed.

The control unit 112 determines a next process that should be performed by the customer A or B (Step S16). The control unit 112 repeats the above-described procedure until the customers A and B complete the registration of all the commodities they want to purchase (Continuation in Step S16). The control unit 112 successively associates the face image of the customer A or B with commodity information of a commodity he/she wants to purchase, and stores them as commodity registration information in the storage unit 4.

The customers A and B can display a list of the registered commodities in the output unit 5 while in the middle of shopping (Screen Switching in Step S16). The control unit 112 makes (i.e., urges) the customers A and B perform an operation on the output unit 5 to select information to be displayed (Step S17).

When displaying a list of all the commodities is selected (List Displaying in Step S17), a list of commodity information of all the commodities registered by the customers A and B is displayed (Step S18), whereas when individually displaying a list for either the customers A or B is selected (Individual Displaying in Step S17), a list of commodity information of only the commodities registered by either the customers A or B is displayed (Step S19).

For example, the customer A or B can select either the individual displaying of a settlement amount he/she should pay, or the list displaying thereof by operating a touch panel or the like. In the output unit 5, the settlement amount and the like are displayed based on the result of the selection. Conceivable examples of the display method includes those already shown in FIGS. 5 to 9. Note that in the output unit 5, the screen (i.e., the displayed image) may be automatically switched when a commodity is registered or when a predetermined time has elapsed without any operation performed by the customer A or B.

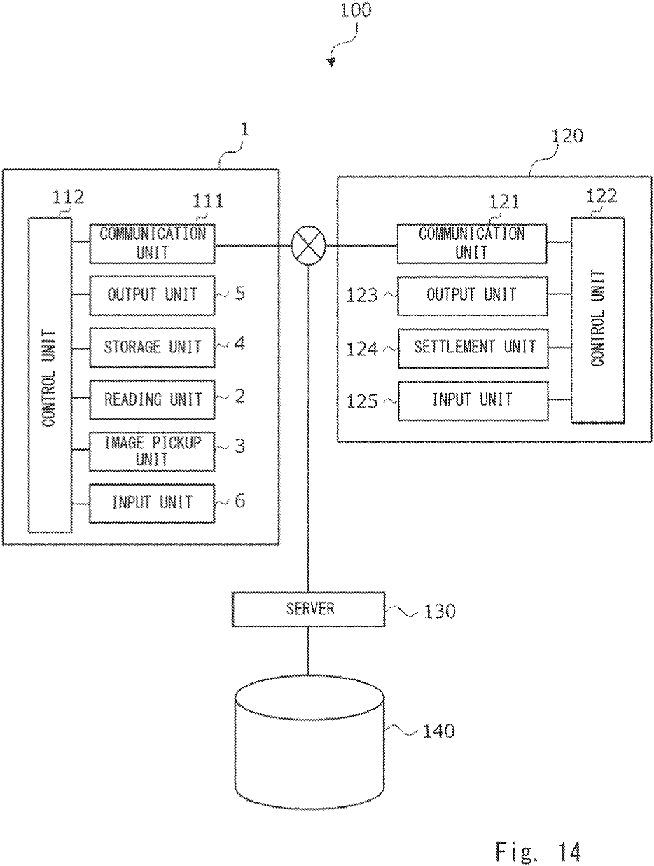

After the customers A and B complete the registration of all the commodities they want to purchase, they proceed to a settlement procedure. When information indicating a settlement is input (Settlement in Step S16), the control unit 112 transmits the commodity registration information to the POS terminal 120 (Step S20). In this example embodiment, the settlement is carried out in the POS terminal 120 of the settlement system 100 shown in FIG. 14. The settlement system 100 will be described later. There are two methods for the settlement. A first settlement method is a method in which one of a lump-sum settlement, equal-share settlements, and individual settlements is selected. A second settlement method is a method in which a lump-sum settlement, equal-share settlements, and an individual settlement are used in a mixed manner.

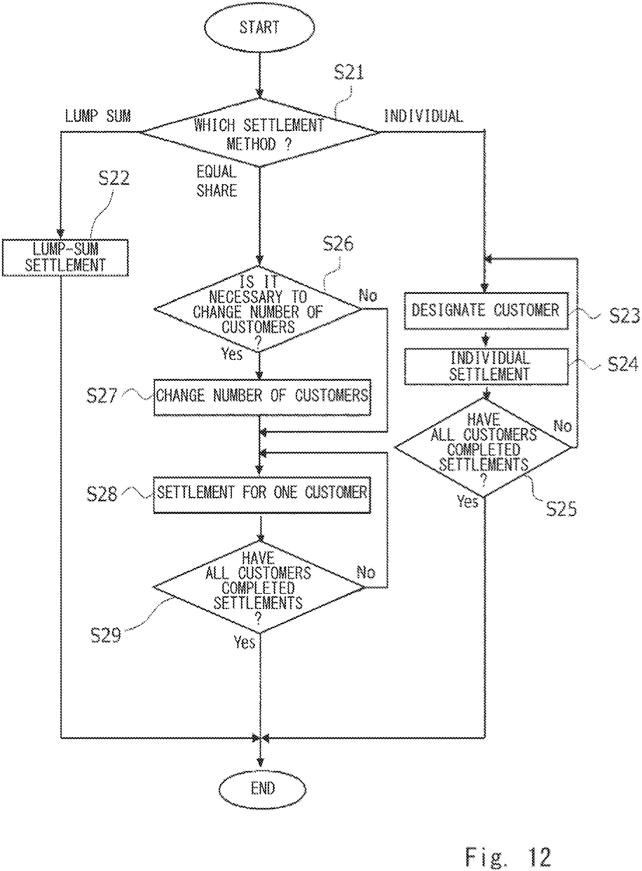

Firstly, a settlement process according to the first settlement method performed by the control unit 122 of the POS terminal 120 will be described with reference to a flowchart shown in FIG. 12.

The control unit 122 of the POS terminal 120 displays, on a customer display unit, choices (a lump-sum settlement, equal-share settlements, and individual settlements) as to how to carry out the settlement, and receives one of the choices selected by the customers A and B (Step S21). The customer display unit is composed of (i.e., formed by) a display equipped with a touch panel, and also serves as an output unit 123 and an input unit 125.

When the customers A and B select the lump-sum settlement (Lump Sum in Step S21), either of the customers A and B pays for all the registered commodities in a lump sum, and a receipt is issued (Step S22). With this, the settlement process is finished.

When the customers A and B select the individual settlements (Individual in Step S21), they designate a customer who will carry out his/her settlement first (Step S23), and the designated customer pays only for the commodities registered by him/her (Step S24). Note that when a customer is designated, the images of the customers A and B are displayed.

Next, the control unit 122 determines whether or not the individual settlements have been completed for all the customers (Step S25). For example, when the customer A has already carried out the individual settlement first and the customer B has not carried out the settlement yet (No in Step S25), then the customer B carries out the settlement. As the settlement for the customer B is completed, a receipt is issued (Yes in Step S25), and the settlement process is finished.

Alternatively, when the customers A and B select the equal-share settlements (Equally Divided in Step S21), the control unit 122 makes (i.e., urges) the customers A and B perform an operation on the customer display unit to select whether to carry out equal-share settlements among all the customers who have registered the commodities or to carry out equal-share settlements among some of the customers (Step S26).

For example, in the case where there are three customers, they can select whether to carry out the equal-share settlements among all three customers or to carry out the equal-share settlements among (i.e., between) only two of the three customers. When it is necessary to change the number of persons (i.e., customers) who will carry out the equal-share settlements (Yes in Step S26), they change the number of persons who will carry out the equal-share settlements by performing an operation on the customer display unit (Step S27). When no change is necessary (No in Step S26), the process proceeds to the next process.

Each of the customers A and B pays an equal share of the total price (Step S28). Next, the control unit 122 determines whether or not the equal-share settlements have been completed for all the customers (Step S29). For example, when the customer A has already paid the equal share of the total price first, but the customer B has not carried out the settlement yet (No in Step S29), then the customer B carries out the settlement. As the settlement of the customer B is completed, a receipt is issued (Yes in Step S29), and the settlement process is finished.

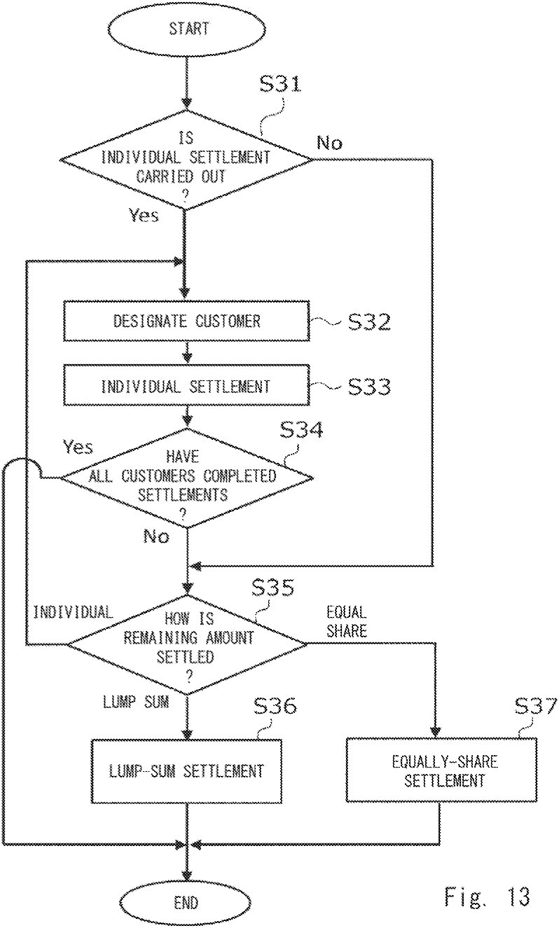

Next, processes that are performed in the case where a lump-sum settlement, an individual settlement, and equal-share settlements are used in a mixed manner, i.e., processes performed in the second settlement method, will be described with reference to a flowchart shown in FIG. 13.

Firstly, the control unit 122 makes (i.e., urges) the customers A and B perform an operation on the customer display unit to select whether or not to carry out an individual settlement (Step S31). When the individual settlement is selected (Yes in Step S31), the customers are made (i.e., urged) to select one of them who will carry out the individual settlement (Step S32), and the selected customer carries out the individual settlement for him/her (Step S33). Note that when a customer is selected, the images of the customers A and B are displayed.

Next, the control unit 122 determines whether or not the individual settlements for all the customers have been completed (Step S34). When the individual settlements for all the customers have already been completed (Yes in Step S34), there is no remaining amount of money to be paid, so that the settlement process is finished.

When the individual settlements for all the customers have not been completed yet (No in Step S34), the control unit 122 makes (i.e., urges) the customers A and B perform an operation on the customer display unit to select a settlement method for the remaining amount (Step S35). When the individual settlement is also selected for the remaining amount (Individual in Step S35), the process returns to the step S32, and the processes in the step S32 and the subsequent steps are performed.

When the lump-sum settlement by one of the customers is selected for the remaining amount (Lump Sum in Step S35), that customer carries out the lump-sum settlement (Step S36). Alternatively, when the equal-share settlements by some or all of the customers are selected (Equally Divided in Step S35), they carry out the equal-share settlements (Step S37). After these settlements are carried out, a receipt is issued, and the settlement process is finished.

Details of the lump-sum settlement, the individual settlements, and the equal-share settlements are same as those that have already been described.

Note that when the individual settlements are not selected in the step S31 (No in Step S31), the process proceeds to the step S35, in which either the lump-sum settlement or the equal-share settlements are selected.

Next, the settlement system 100 will be described with reference to FIG. 14. FIG. 14 is a block diagram showing the settlement system 100 including the commodity registration apparatus 1 according to the second example embodiment.

The settlement system 100 includes the commodity registration apparatus 1, a POS terminal 120, a server 130, and a database 140.

As described above, the commodity registration apparatus 1 is provided in the shopping cart 10, and includes the communication unit 111, the control unit 112, the storage unit 4, the output unit 5, the input unit 6, the reading unit 2, and the image pickup unit 3. The output unit 5 and the input unit 6 are composed of (i.e., formed by) a display equipped with a touch panel.

The communication unit 111 can wirelessly communicate with a communication unit 121 and the server 130. The control unit 112 is connected to each of the units, and has a function of controlling them.

The POS terminal 120 includes the communication unit 121, a control unit 122, an output unit 123, a settlement unit 124, and an input unit 125.

The communication unit 121 can wirelessly communicate with the commodity registration apparatus 1, and can communicate with the server 130 wirelessly or through a cable.

The output unit 123 outputs commodity registration information for each customer while associating commodity information with the customer. The commodity registration information for each customer includes a face image of that customer (i.e., a customer A or B), information about commodities registered by that customer such as commodity names, unit prices, and number of commodities, and other various information related to the settlement, such as a settlement amount for that customer determined according to the choice of the settlement method. Specifically, the output unit 123 is a display, a printer, or the like. Specifically, the input unit 125 is a touch panel, buttons, or the like, and receives an input made by a store clerk or a customer.

In the POS terminal 120, the settlement unit 124 has a function of carrying out a settlement by exchanging the price (e.g., money) for commodities between a store clerk and a customer by cash, a credit card, electronic money, or the like.

The control unit 122 controls the above-described function included in the POS terminal 120.

The communication unit 111 of the commodity registration apparatus 1 transmits commodity registration information for each customer stored in the storage unit 4 to the POS terminal 120. The POS terminal 120 receives the commodity registration information for each customer through the communication unit 121, and displays this information in the output unit 123. The displayed information may be composed of just letters and numbers, or may be composed of the face images of the customers A and B and commodities which are arranged side by side as described above. In this way, the store clerk can carry out the settlement process with the customers A and B by using the settlement unit 124 according to the settlement method selected by the customers.

The server 130 is a store server installed in the store, and can access the database 140. The server 130 accumulates (i.e., stores) information about the above-described settlement in the database 140.

As described above, according to the commodity registration apparatus in accordance with this example embodiment, even when a plurality of customers use one shopping cart together, it is possible to enable each of the customers to know the amount he/she needs to individually pay without performing any additional calculation, and also to carry out the settlement by a method selected by the customers.

Further, according to the settlement method in accordance with this example embodiment, it includes: a step of reading commodity identification information for identifying a commodity; a step of photographing a customer who has made an apparatus read the commodity identification information; a step of identifying the customer based on a photograph image, and storing the identified customer while associating the customer with the commodity; and a step of outputting the commodity and the customer while associating them with each other. Therefore, even when a plurality of customers use one shopping cart together, it is possible to enable each of the customers to know the amount he/she needs to individually pay.

### Third Example Embodiment

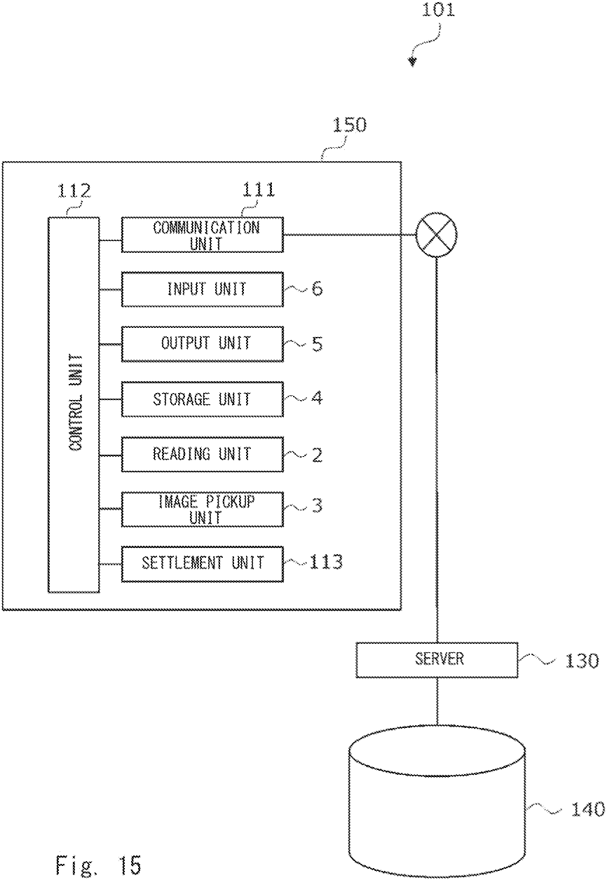

In this example embodiment, processes through which customers A and B carry out a settlement(s) by themselves by using a shopping cart 10 will be described with reference to FIG. 15.

A settlement system 101 includes a commodity registration apparatus 150, a server 130, and a database 140. The commodity registration apparatus 150 has a configuration identical to that shown in FIG. 14, except for a settlement unit 113, and therefore descriptions of the components/structures other than the settlement unit 113 will be omitted.

The settlement unit 113 has a function by which the customers A and B pay the price (e.g., money) for commodities by themselves by cash, a credit card, electronic money, or the like by using the commodity registration apparatus 150. Therefore, after the customers A and B register commodities and select a settlement method therefor, they can carry out the settlement by themselves by using the commodity registration apparatus 150 without carrying the commodities to a cash register. The control unit 112 of the commodity registration apparatus 150 carries out the settlement process. Details of this process are the same as those of the settlement process (the flowcharts shown in FIGS. 12 and 13) performed by the control unit 122 of the POS terminal 120 in the second example embodiment. After the settlement process, the control unit 122 transmits the result of the settlement to the server 130.

As described above, according to the commodity registration apparatus in accordance with this example embodiment, the customers A and B can carry out the settlement by themselves by a desired settlement method without getting in a waiting line at a cash register.

### Example of Hardware Configuration

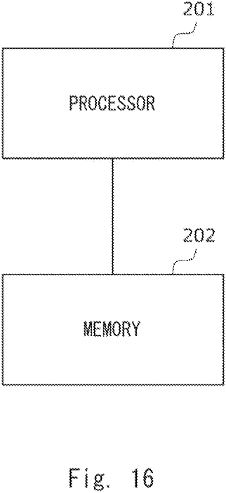

FIG. 16 is a block diagram showing an example of a hardware configuration for carrying out a settlement process. This hardware configuration includes a processor 201 and a memory 202.

The processor 201 performs processes performed by the commodity registration apparatus 1 described above with reference to the flowcharts in the above-described example embodiments by loading a computer program (a settlement program) from the memory 202 and executing the loaded computer program. Note that the settlement program causes a computer to perform: a step of reading commodity identification information for identifying a commodity; a step of photographing a customer who has made an apparatus read the commodity identification information; a step of identifying the customer based on a photograph image and storing the identified customer while associating the customer with the commodity; and a step of outputting the commodity and the customer while associating them with each other.

The processor 201 may be, for example, a microprocessor, an MPU (Micro Processing Unit), or a CPU (Central Processing Unit). The processor 201 may include a plurality of processors.

The memory 202 is composed of a combination of a volatile memory and a nonvolatile memory. The memory 202 may include a storage located remotely from the processor 201. In this case, the processor 201 may access the memory 202 through an I/O interface (not shown).

In the example shown FIG. 16, the memory 202 is used to store a group of software modules. The processor 201 can perform processes performed by the commodity registration apparatus 1 described in the above-described example embodiments by loading the group of software modules from the memory 202 and executing the loaded software modules.

Each processor executes one or a plurality of programs including a group of instructions for causing a computer to perform an algorithm described above with reference to the drawings. The program can be stored in various types of non-transitory computer readable media and thereby supplied to computers. The non-transitory computer readable media includes various types of tangible storage media. Examples of the non-transitory computer readable media include a magnetic recording medium (such as a flexible disk, a magnetic tape, and a hard disk drive), a magneto-optic recording medium (such as a magneto-optic disk), a Compact Disc Read Only Memory (CD-ROM), a CD-R, and a CD-R/W, and a semiconductor memory (such as a mask ROM, a Programmable ROM (PROM), an Erasable PROM (EPROM), a flash ROM, and a Random Access Memory (RAM)). Further, the program can be supplied to computers by using various types of transitory computer readable media. Examples of the transitory computer readable media include an electrical signal, an optical signal, and an electromagnetic wave. The transitory computer readable media can be used to supply programs to computer through a wire communication path such as an electrical wire and an optical fiber, or wireless communication path.

Note that the present invention is not limited to the above-described example embodiments, and they may be modified as desired without departing from the scope and spirit of the invention. For example, when a customer cancels a commodity that he/she has already registered, the customer may read the commodity again by using the reading unit, and the apparatus or the system may output the commodity to be canceled and the customer who has read the commodity while associating them with each other.

Although the present invention has been described above with reference to example embodiments, the present invention is not limited to the above-described example embodiments. The configuration and details of the present invention may be modified within the scope of the present invention in various ways that can be understood by those skilled in the art.

This application is based upon and claims the benefit of priority from Japanese patent application No. 2020-017174, filed on Feb. 4, 2020, the disclosure of which is incorporated herein in its entirety by reference.

### Reference Signs List

1, 150 COMMODITY REGISTRATION APPARATUS
2 READING UNIT
3 IMAGE PICKUP UNIT
4 STORAGE UNIT
5, 123 OUTPUT UNIT
6, 125 INPUT UNIT
10 SHOPPING CART
11 BASKET
100, 101 SETTLEMENT SYSTEMS
111, 121 COMMUNICATION UNIT
112, 122 CONTROL UNIT
113, 124 SETTLEMENT UNIT
120 POS TERMINAL
130 SERVER
140 DATABASE
201 PROCESSOR
202 MEMORY

What is claimed is:

1. A commodity registration apparatus comprising:
a reader that reads commodity identification information for identifying a commodity;
an image pickup unit that photographs each of a plurality of customers who have made the reader read the commodity identification information;
a memory that stores commodity information of a commodities that the ; respective customers purchase:
an output unit that outputs the commodity information;
an input unit that receives an input made through an operation performed by the customer;
a controller that controls the reader, the image pickup unit, the memory, the output unit and the input unit; and
a calculation unit that calculates a settlement amount of the commodities, wherein
the controller acquires the commodity information based on the commodity identification information received from the reader, identifies each of the plurality of customers based on photograph images received from the image pickup unit, and stores, in the memory, the acquired commodity information and the identified customers as commodity registration information while associating them each the controller outputs the commodity information associated with the customers to the output unit while associating them with each other,
the input unit receives a choice about a settlement method from the customer in a settlement for a total amount of all the commodities of which the commodity identification information has been read,
the settlement method is selected from a plurality of settlement methods including a lump-sum settlement for the total amount and an individual settlement based on settlement amounts for respective customers, and
the control unit outputs a settlement amount corresponding to the selected settlement method to the output unit.

2. The commodity registration apparatus according to claim 1, wherein the controller identifies each of the plurality of customers based on a face image of each of the plurality of customers.

3. (canceled)

4. The commodity registration apparatus according to claim 1, wherein the controller makes the output unit display a settlement amount of the commodity for each of the customers.

5. The commodity registration apparatus according to claim 1, further comprising communication unit capable of communicating with a POS terminal, wherein
the controller transmits the commodity registration information stored in the memory to the POS terminal through the communication unit.

6. A settlement system comprising:
a commodity registration apparatus according to claim 1 and
a POS terminal capable of communicating with the commodity registration apparatus.

7. A settlement method comprising:
reading commodity identification information for identifying a commodity;
photographing each of a plurality of customers who have made an apparatus read the commodity identification information;
acquiring commodity information based on the commodity identification information, identifying each of the plurality of customers based on a photograph image, and storing the acquired commodity information and the identified customers while associating them with each other;
receiving an input made through an operation performed by the customer;
calculating a settlement amount of the commodities; and
outputting the commodity information and the customer while associating them with each other, wherein
in the receiving of the input, a choice about a settlement method is received from the customer in a settlement for a total amount of all the commodities of which the commodity identification information has been read,
the settlement method is selected from a plurality of settlement methods including a lump-sum settlement for the total amount and an individual settlement based on settlement amounts for respective customers, and
in the outputting, a settlement amount corresponding to the selected settlement method is output.

8. A non-transitory computer readable medium storing a settlement program for causing a computer to perform:
a step of reading commodity identification information for identifying a commodity;
a step of photographing each of a plurality of customers who have made an apparatus read the commodity identification information;
a step of acquiring commodity information based on the commodity identification information, identifying each of the plurality of customers based on a photograph image, and storing the acquired commodity information and the identified customers while associating them with each other;
receiving an input made through an operation performed by the customer; calculating a settlement amount of the commodities; and
a step of outputting the commodity information and the customer while associating them with each. other, wherein
in the receiving of the input, a choice about a settlement method is received from the customer in a settlement for a total amount of all the commodities of which the commodity identification information has been read,
the settlement method is selected from a plurality of settlement methods including a lump-sum settlement for the total amount and an individual settlement based on settlement amounts for respective customers, and
in the outputting, a settlement amount corresponding to the selected settlement method is output.

9. The commodity registration apparatus according to claim 1, wherein
the settlement method comprises:
individually paying a part of the total amount; and
paying the rest of the total amount, which is an amount obtained by subtracting the part from the total amount, through a lump-sum settlement for the rest of the total amount or equal-share settlements for the rest of the total amount.
